(19) United States
(12) Patent Application Publication
(10) Pub. No.: US 2014/0078857 A1
(43) Pub. Date: Mar. 20, 2014

(54) APPARATUS FOR MIXING MEASURED AMOUNTS OF CONCENTRATE WITH A DILUTANT AND METHOD OF USING SAME

(71) Applicant: FIT SYSTEMS, LLC, Reno, NV (US)

(72) Inventors: Steven D. Nelson, Buena Park, CA (US); Christian M. Olsen, Salt Lake City, UT (US)

(73) Assignee: FIT SYSTEMS, LLC, Reno, NV (US)

(21) Appl. No.: 13/623,737

(22) Filed: Sep. 20, 2012

(51) Int. Cl. B65D 83/14; B01F 15/02

(52) U.S. Cl. 366/182.1; 222/145.5; 222/325

(57) ABSTRACT

A vertical mixing chamber with a forwardly projecting dock having a receiver in its top wall for receiving the spout of a pre-pressurized cartridge mounted from the container by a holder providing for reciprocation to engage a spout with the receiver and open a valve in the cartridge.

### BACKGROUND OF THE INVENTION

1. Field of the Invention

The present invention relates to a device for containing, storing and combining concentrate, supplements or other agents with a carrier or dilutent such as water.

2. Brief Description of Related Art

Description of the Prior Art

Each day tens of thousands of disposable drinking and applicator bottles are employed in home and industrial use for beverages, disinfectants, cleaning and the like. Applicator bottles typically incorporate sprays or squeeze release and are frequently employed for a single fill resulting in discard after dispensing the contained liquid, for instance on the order of 28 ounces. The process of filling, storage and shipping such containers is extremely labor intensive and expensive. As an example, disinfectants and cleaners are often premixed on an assembly line to fill bottles and package cartons of 36 or so to be carted to storage or shipped thus generating liquid of substantial bulk and weight. This can result in subjecting workers handling same to fatigue and injury from lifting and manipulating the heavy cartons about for transport and storage.

For single use bottles disposal can present a challenge and contributes significantly to the filling of landfills with plastics that resist degrading and decomposition. In some applications, as for instance, in commercial and industrial settings, efforts have been made to reuse spray bottles and the like by refilling them with a mix of, for instance, disinfectant and water. Often times it is necessary to dedicate an employee to simply refilling the spray bottles with cleaning and disinfecting agents to ready the reconstituted liquid to perform its function. While helpful in reducing the magnitude of discarded bottles, these procedures may require that each day empty and partially empty bottles be collected at a central location for refilling. The refilled bottles must then be distributed to work sites thus taking a toll on the efficient operation of an institution. In some instances, the disinfecting agent may be toxic or harmful to the skin or eyes thus adding to the risk and inconvenience of refilling through a conventional bottle neck.

In some industrial settings, the bottles for cleaning or disinfecting are used at different locations such as dishwashing or laundry stations, food dispensing stations, paint or epoxy mixing stations and at a myriad of other stations. The operator thus has the option of either purchasing the disinfectant fluid in bottles already mixed or possibly purchasing the concentrate such as soaps, disinfectants, paint pigments, epoxies and the like separately and mixing or diluting or proportioning them on site. Thus, there exists the dilemma that mixing is either accomplished at the place of manufacturing to bottle the diluted liquid cleaner or disinfectant for shipment as relatively heavy, bulky product or employing a dedicated station at the industrial facility for refilling and mixing, both of which are undesirable and unsatisfactory solutions.

Efforts have been made to overcome these shortcomings by providing a proportioning system for attachment to, for instance, separate bottles of concentrate and dilutent. A device of this type is shown in U.S. Pat. No. 6,036,057 to Poutiatine. While serving to provide a convenient means for drawing fluid from a pair of containers and proportionally mixing same, such a device is rather complicated, expensive to manufacture and can prove inconvenient and unreliable in use.

At present, there exists an opportunity to mix concentrate with a dilutent in an applicator container. It has been recognized that it would be convenient to marry a concentrate cartridge with a dilutent container to be portable as a unit such that the cartridge would be readily available for removal and mixing of concentrate and dilutent in the applicator container. A device of this type is shown in U.S. Pat. No. 4,925,066 to Rosenbaum. Such devices suffer the shortcoming that their use is still labor intensive in that the user, to employ the benefits of the device, is required to detach the concentrate container and manually pour the contents thereof into the applicator container, a time consuming, messy and, in the case of toxic products, a high risk task.

Other efforts have led to the proposal of concentrate cartridge or bubble disposed in the neck or along the interior of a mixing container and penetrable by a spike or the like to release the concentrate from the bubble or cartridge. A device of this type is shown in U.S. Pat. No. 5,836,479 to Klimt. While helpful in protecting the user from exposure to concentrate, such devices have limited usage in that there is no provision for releasing any measured amount of concentrate short of the entire charge stored in the cartridge or bubble.

Other efforts to mix concentrate or agents with dilutent in a mixing chamber also apply the concept of utilizing cartridge chambers to dispense concentrate typically under gravity flow into a mixing bottle or applicator. Devices of this type are shown in U.S. Pat. No. 6,851,580 and in U.S. Patent Publication No. 2004/0238566, both to Stank.

In the prior work of a co-inventor, it was proposed to provide an applicator/mixing container configured with a dock constructed to receive a concentrate cartridge which either directly or indirectly penetrates the wall of the container to discharge concentrate to the mixing container, either under gravity flow or manual pressurization. While satisfactory for the objective sought in that patent, the device suffers the shortcoming that it is expensive to manufacture, cumbersome to operate and sometimes fails to dispense accurately measured quantities of concentrate.

Efforts have been made to provide for mixing of hazardous concentrate in such a manner as to provide some degree of safety and also provide for discharge of the entire charge of concentrate in one shot. A device of this type is shown in U.S. Patent Publication 2009/0277929 to Larson. Such devices, while serving to irreversibly lock the concentrate cartridge to restrict accidental removal before full discharge of the cartridge, suffer the shortcoming that the mechanism for installing and operation of the cartridge is inconvenient to use and does not allow for selected discharge of metered quantities of the concentrate.

In unrelated art, so called, aerosol can sprays have long been known for spraying liquid under pressure and often for atomizing the sprayed liquid. As known by those skilled in that art, aerosol can storage and spray takes advantage of the fact that the vapor of a liquid with its boiling point slightly lower than room temperature will vaporize inside the can to pressurize the liquid to a pressure higher than atmospheric pressure to thereby expel the payload. As the gas escapes it is immediately replaced by evaporating liquid. Initially, chlorofluorocarbons (CFCs) were often used as the propellant but since the Montreal Protocol came into force in the late 1980's those propellants have been replaced. Common replacements are mixtures of volatile hydrocarbons, typically propane, n-butane and isobutane, dimethyl ether (DME) and methyl ethyl ether are also used. Nitrous oxide and carbon dioxide are also used as propellants to deliver food stuff such as whipped cream and other cooking spray. Thus, numerous styles of aerosol cans have been known for many years.

An example of a pressure vessel together with dimethyl ether with dispensing valve is shown in U.S. Pat. No. 1,800,156 to Rotheim. It is known to control the flow from aerosol dispensers by special design of the actuator button. An arrangement for such control is shown in U.S. Pat. No. 3,912,132 to Stevens.

Aerosol cans have also been known for spraying hair spray and medicines in atomized form. These various aerosol dispenser systems can be bag-in-can systems or BOV “Bag on Valve”, www.bagonvalve.com. In that arrangement, the product from the pressurized agent is hermetically sealed in a multi-layered laminated pouch which maintains complete formulation integrity so only pure product is dispensed. These devices are typically used by sun care marketers. A more recent development is the 2K (two component) aerosol dispenser which has a main component stored in a main chamber and an applicator in a second accessory chamber. The applicator is intended to activate the 2K aerosol when the accessory container is broken so that the two components can mix.

Even with the coexistence of pressurized cans, concentrate cartridges and mixing chambers, to date artisans have been faced with the dilemma of either utilizing concentrate cartridges which typically drain under gravity influence or manual pumping or often provide for complete evacuation thereof upon one actuation or selecting an aerosol device for spraying of atomized liquid but without the benefits of mixing with a dilutent.

### SUMMARY OF THE INVENTION

The Apparatus of the present invention includes a mixing container formed with a dock mounting a receiver and a coupler for mounting a holder configured to receive a pre-pressurized can charged with a concentrate for reciprocation of the can within the holder to selectively dispense measured quantities of concentrate through the receiver into the mixing chamber.

The method of the present involves selection of a mixing container with a horizontal dock including a receiver and holding a pre-pressurized concentrate cartridge for reciprocation relative to the receiver to discharge concentrate under pressure through a spout into the container.

### BRIEF DESCRIPTION OF THE DRAWINGS

FIG. 1 is a perspective view of a mixing and applicator apparatus embodying the present invention;

FIG. 2 is a right hand side view of the apparatus shown in FIG. 1 but with the spray nozzle removed;

FIG. 3 is an exploded perspective view, in reduced scale, of the apparatus shown in FIG. 1;

FIG. 3 is an exploded perspective view similar to FIG. 2 but in reduced scale;

FIG. 4 is a top plan view of the apparatus shown in FIG. 1 but with the holder disconnected from the mixing container;

FIG. 5 is a perspective view of the apparatus shown in FIG. 1 but with the holder removed from the container;

FIG. 6 is a right hand side view, in enlarged scale of the apparatus shown in FIG. 1, partially exploded;

FIG. 7 is a perspective view similar to FIG. 6;

FIG. 8 is a vertical sectional view in enlarged scale of the apparatus shown in FIG. 1 but with the holder removed;

FIG. 9 is a side view, partially in section, of the apparatus shown in FIG. 8 but in reduced scale; and

FIG. 10 is a vertical sectional view similar to FIG. 9 but in enlarged scale.

### DETAILED DESCRIPTION OF THE PREFERRED EMBODIMENTS

There has a been a great demand for a personal container and concentrate cartridge for rapidly and conveniently mixing a concentrate such as a detergent, disinfectant or flavoring with a dilutent to provide a working mixture. This is the objective to which the present invention is directed.

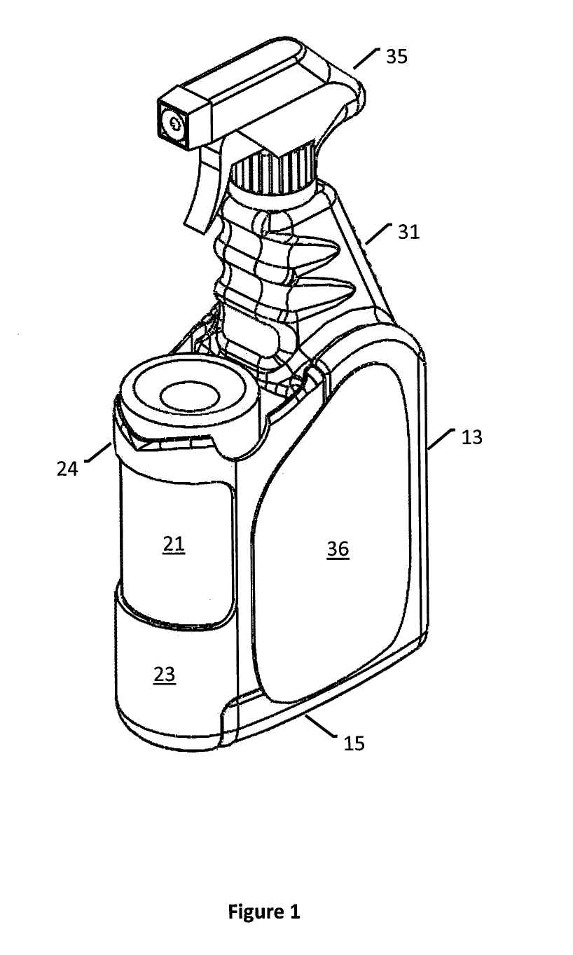

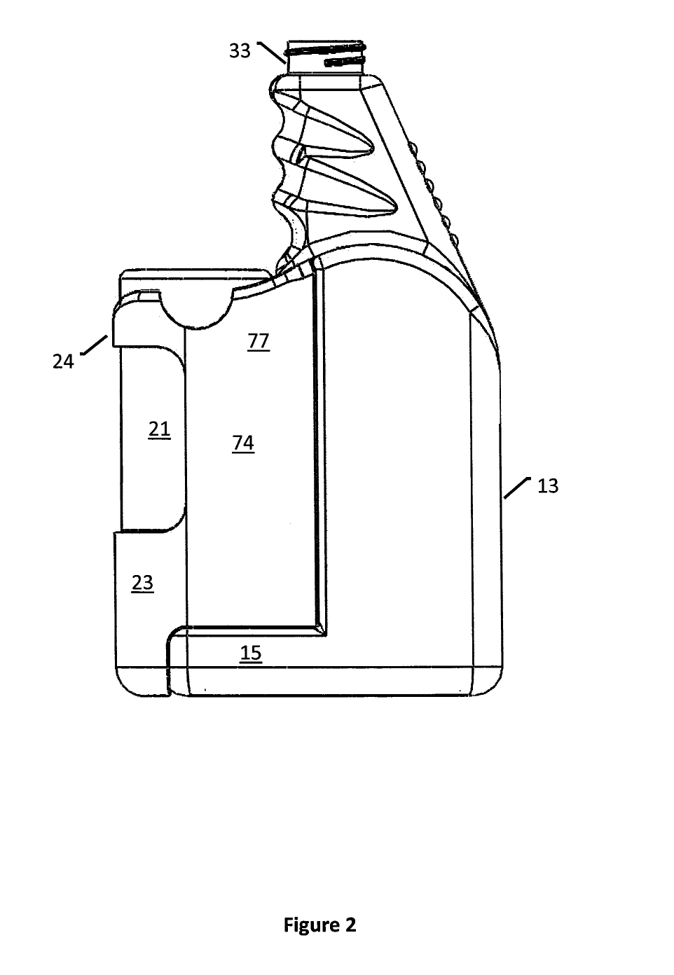

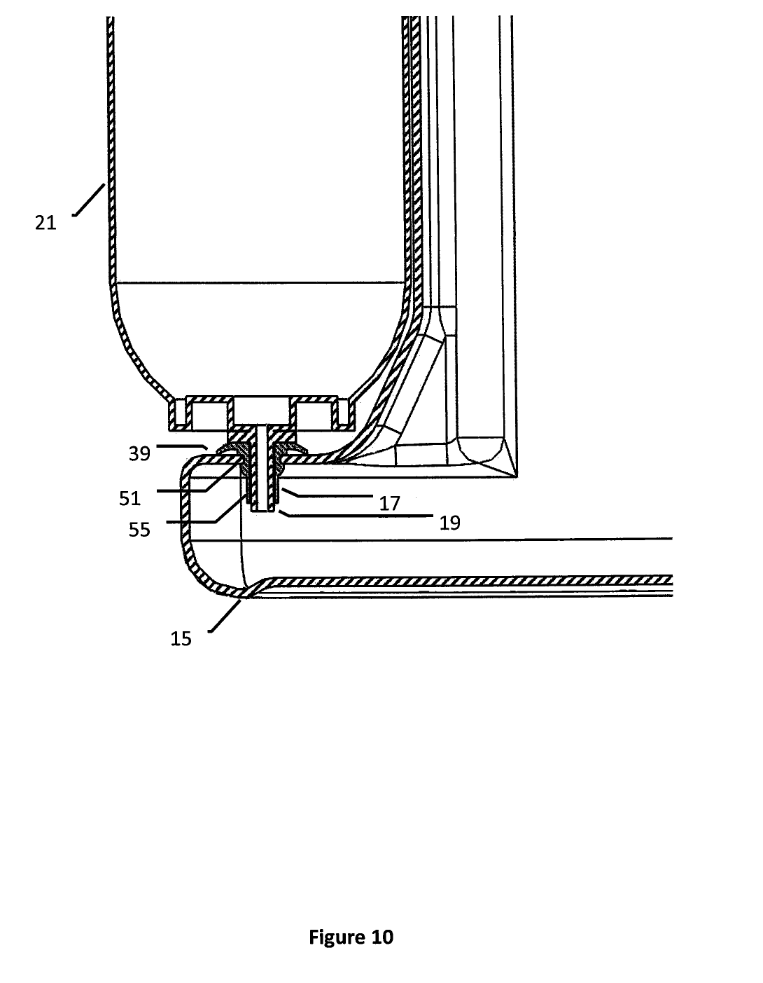

Referring to FIGS. 1-3, the concentrate metering and mixing apparatus of the present invention includes, generally, a vertical applicator and mixing container 13 formed in its bottom extremity with a forwardly projecting foot defining a horizontal dock 15 which mounts an upwardly opening receiver 17 (FIG. 10) configured to mate with a downwardly projecting stem 19 of a pre-pressurized concentrate container 21 carried loosely fit in a holder 23 secured to the front of the container 13 to align the stem 19 with the receiver 17.

For the purposes of defining the present invention, the following terms are intended to have the meaning indicated:

| | |
|---|---|
| mixing | a receptacle for receiving liquid for mixing with a |
| container: | concentrate |
| pre- | a can or container of concentrate containing a propellant |
| pressurized | which may be in liquid form having a boiling point slightly |
| cartridge: | lower than room temperature and may be in the form of |
| | Chlorofluorocarbon, volatile hydrocarbons, nitrous oxide, |
| | carbon dioxide, hydrofluoroalkanes or yet to be developed |
| | substitutes which vaporize at ambient temperature to act |
| | as a propellant |
| concentrate: | concentrated liquid or powder which may be dissolved in a |
| | dilutant such as water as a supplement, solvent, detergent |
| | or the like |
| receiver: | a grommet type device for receiving tubular stem |
| valve: | a device for controlling the flow of fluid in at least one |
| | direction |

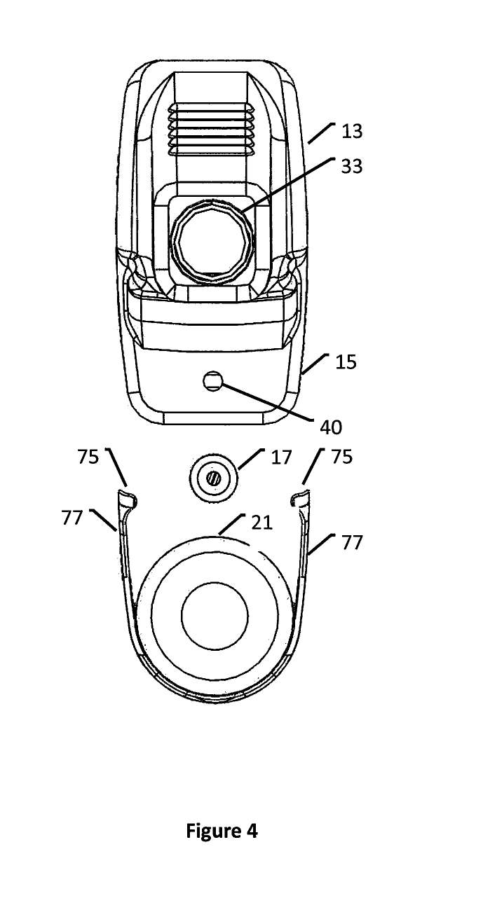

Referring to FIGS. 1 and 4, the container 13 is formed in its front wall with a forwardly projecting coupler track, generally designated 74, configured with laterally, oppositely projecting flanges 71 cooperating to form laterally opening vertical grooves 73 for receipt of laterally in-turned tongues 75 formed in rearwardly projecting arms 77 formed in a coupler, generally designated 76, in the holder. In a preferred embodiment, we construct the coupler 74 and holder 23 to provide an interference or friction fit to thus cause the holder to releasably lock on the coupler with some resistance to release. In one embodiment the holder arms 77 are resilient and are formed with a set spacing the tongues 75, in the relaxed position, a distance apart less than the distance between the grooves 73 so that, in the coupled condition, the tongues will be pressed into the respective grooves with sufficient force to apply frictional resistance to relative vertical shifting to resist release from the coupled condition. In one embodiment the tongues are configured to slide vertically downwardly into grooves 73 and in another, such tongues are bulbous in horizontal cross section to snap laterally into similarly shaped grooves. In other embodiments, the tongues 75 are slightly oversized in horizontal cross section as compared to the grooves 73 to provide friction or interference fit.

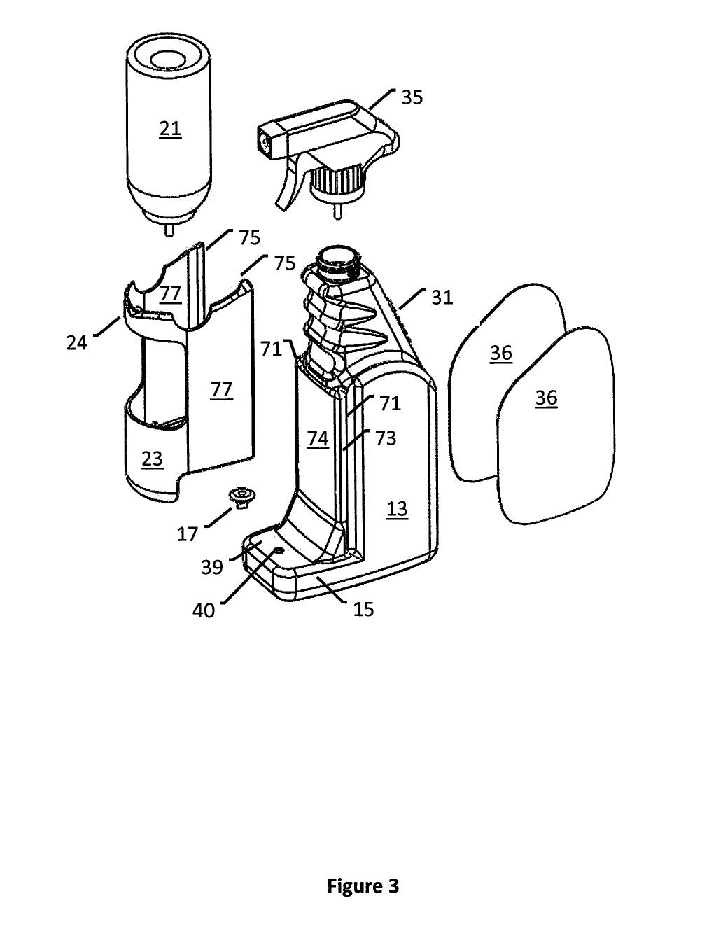

The container 13, in the exemplary embodiment, is in the form of a blow molded, thin wall applicator bottle configured with an upwardly projecting neck 31 terminating in an externally threaded boss 33 for receiving a spray head, generally designated 35 (FIG. 1). In a preferred embodiment, the opposite sides of the container 13 are planer and shaped to receive indicia bearing stickers 36 (FIG. 3).

Referring to FIG. 4, the container 13 is formed with the forwardly projecting dock 15 of hollow construction having a top wall 39 configured with a through bore 40 which receives the receiver 17. The receiver includes a cylindrical grommet 45 formed on its upper extremity with a peripheral stop flange 47 and a downwardly projecting barrel 49 configured intermediately with an exterior gland 51 (FIG. 10) which receives the marginal edge of the wall 39 defining the bore.

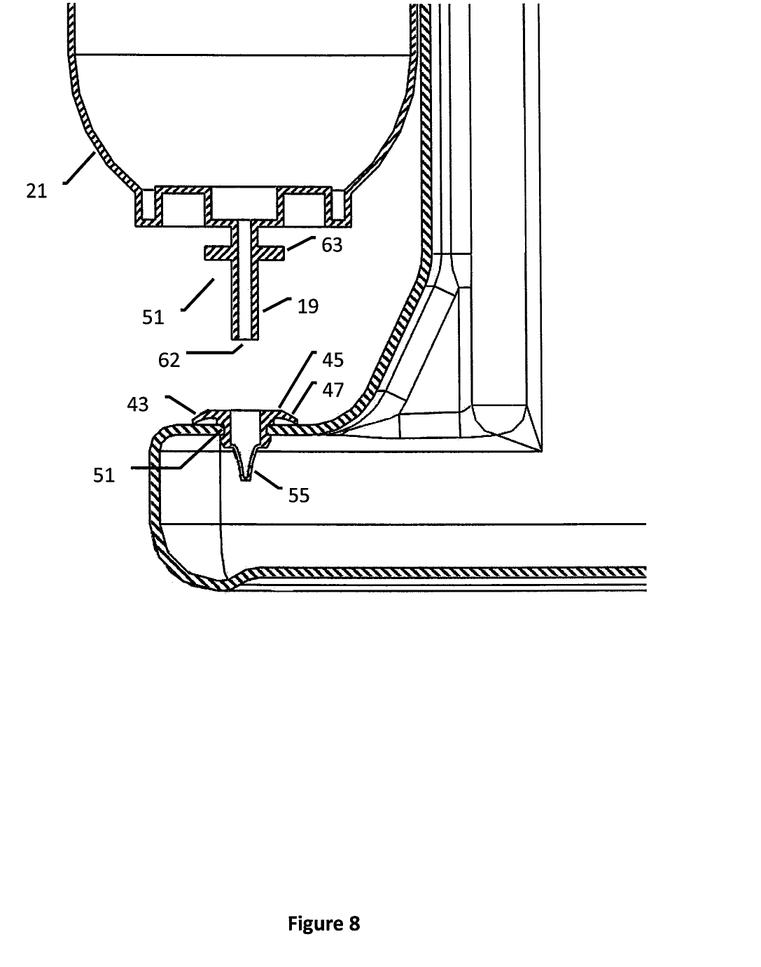

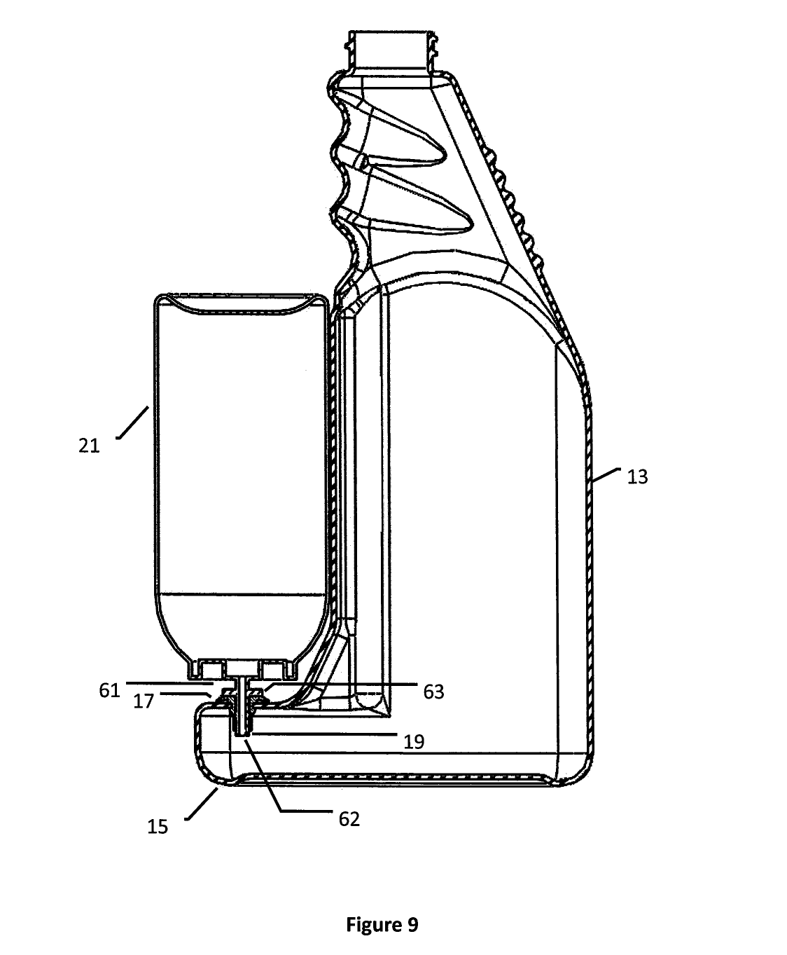

The grommet is configured in its lower extremity with a duckbill valve 55 (FIGS. 8 and 10) constructed to assume a normally closed configuration but penetrable by the stem 19 to open and receive such stems and is disposed.

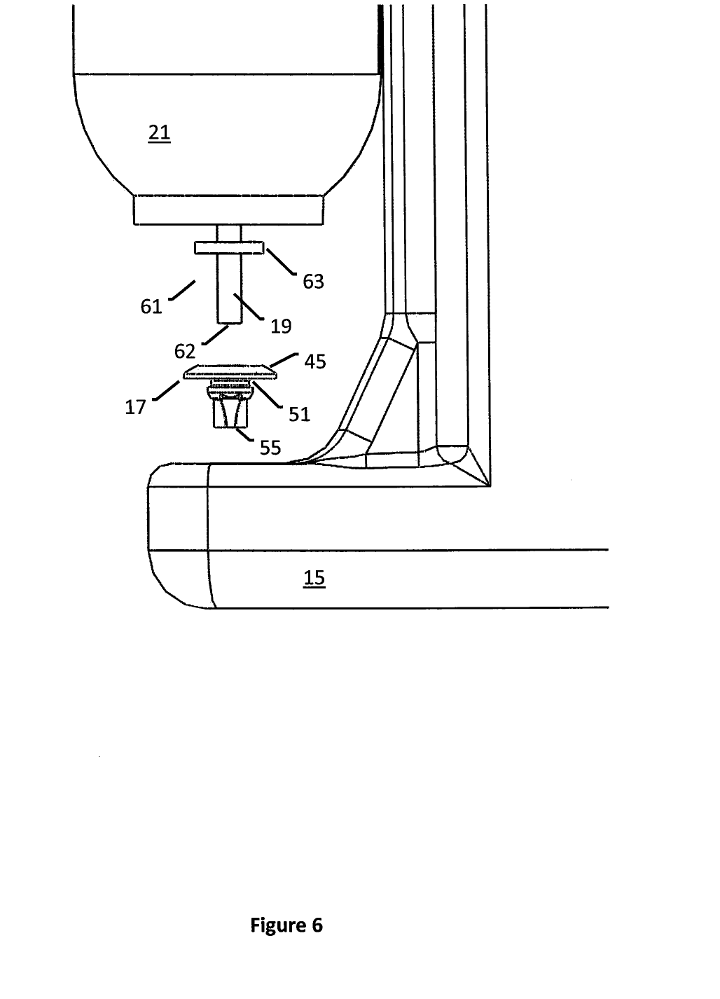

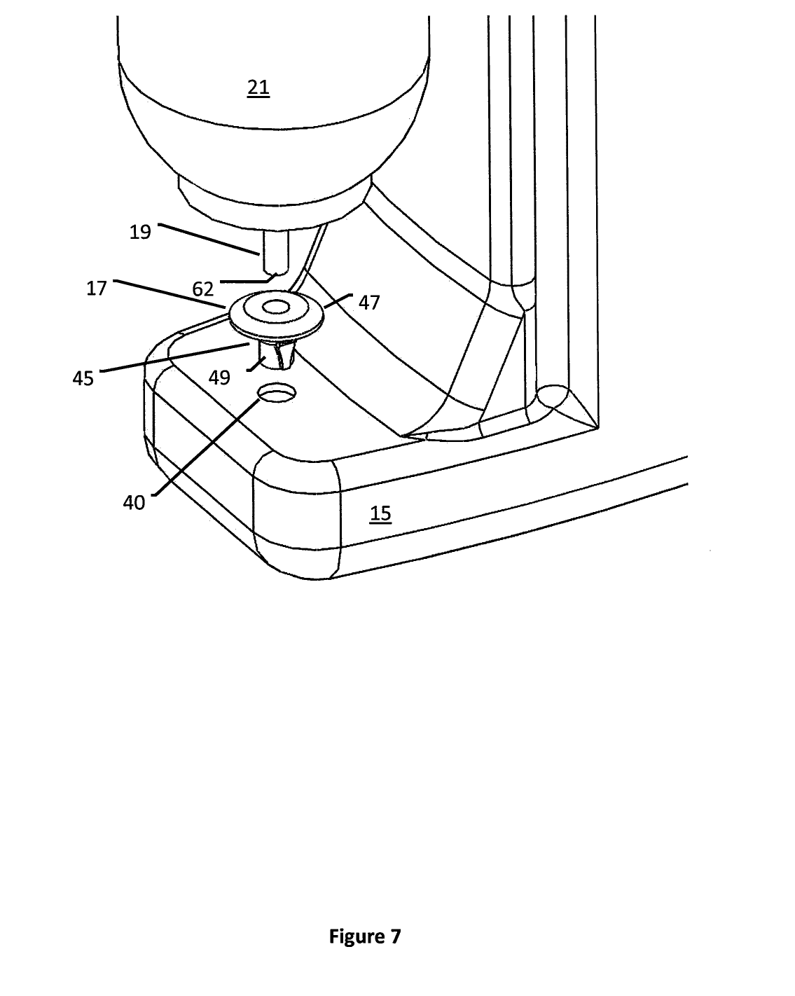

Referring to FIGS. 6 and 7, the pressurized cartridge 21 includes a conventional outlet device, generally designated fitting 61, formed with the spout 19, a medial radially projecting actuation flange 63 which sets on the top surface (FIG. 10) and terminating in a blunt end 62. The outlet device is configured such that, when the stem is inserted in the receiver, the stem will be placed in fluid communication through the duck billed valve to the interior of the foot 15.

In one preferred embodiment, the receiver is formed with a flapper valve and distal of that, an internal stop ring (not shown) which is abutted by the terminal end 62 of the stem so that, after the stem pushes the flapper valve open, the end 62 engages the stop ring such that, upon the user pressing down further on the inverted cartridge 21 against the stopped stem, the stem will be depressed upwardly relative to the cartridge to open the cartridge valve and release a selected quantity of concentrate, depending on how long the stem remains depressed.

The holder 23 is configured with a cylindrical cavity defining a central cylindrical opening defining a clearance of substantially 0.003″ around the pressurized cartridge 21 to thus allow for freedom of vertical reciprocation of the can cartridge 21 in the holder. As will be appreciated by those skilled in the art, the holder 23 functions to provide for free reciprocation of the cartridge 21 and may include, for instance, single or multiple rings 24 sized for free reception of the cartridge and axial alignment thereof. As shown in the exemplary embodiment the ring 24 is a closed ring but, in the other embodiments the holder may include an open ring configured with a pair of acute arms forming over 180° of a circle to constrain the cartridge. In practice, the holder is u-shaped in a horizontal cross section and configured to complement the shape of the container 13.

It will be appreciated that conventional aerosol cartridges may be selected and charged with the desired concentrate and sufficient propellant to provide for pressurized discharge of the propellant. In some embodiments, the pressurized cartridge may be selected with a metering system such that a selected quantity of concentrate is emitted with each single depression of the cartridge 21 to thus be assured that the same quantity is discharged with each operation.

For the exemplary embodiment we have selected what is known to those in the art as a burst valve BV02 for the six ounce cartridge 53*115, available from Spray Products Corporation, 1323 Conshohocken Road, Plymouth Meeting, Pa. 19462.

In any event, it will be appreciated that a quantity of cartridges 21 may be assembled and loaded with concentrate at the manufacturing facility, inventoried and stored for shipping to a distant destination for utilization for the desired application of a mixture incorporating such concentrate. In that regard it will be appreciated that the volume and weight of the individual concentrate cartridges will be relatively small and of light weight as compared to the reconstituted mixture for the end application.

The user will purchase one or more mixture/applicator containers 13, including a holder 23 and, when it is desired to apply a detergent, disinfectant or the like, the cartridge associated with the particular concentrate desired will be selected and slid downwardly into the holder 23 to be guided freely downwardly therein to by the 0.003″ clearance around the periphery thereof to thus be nested in the holder with the spout 19 centered.

Then, with the pistol grip spray applicator or the like removed from the threaded boss 33, a dilutent such as water may be poured into the container 13 and ready for mixture.

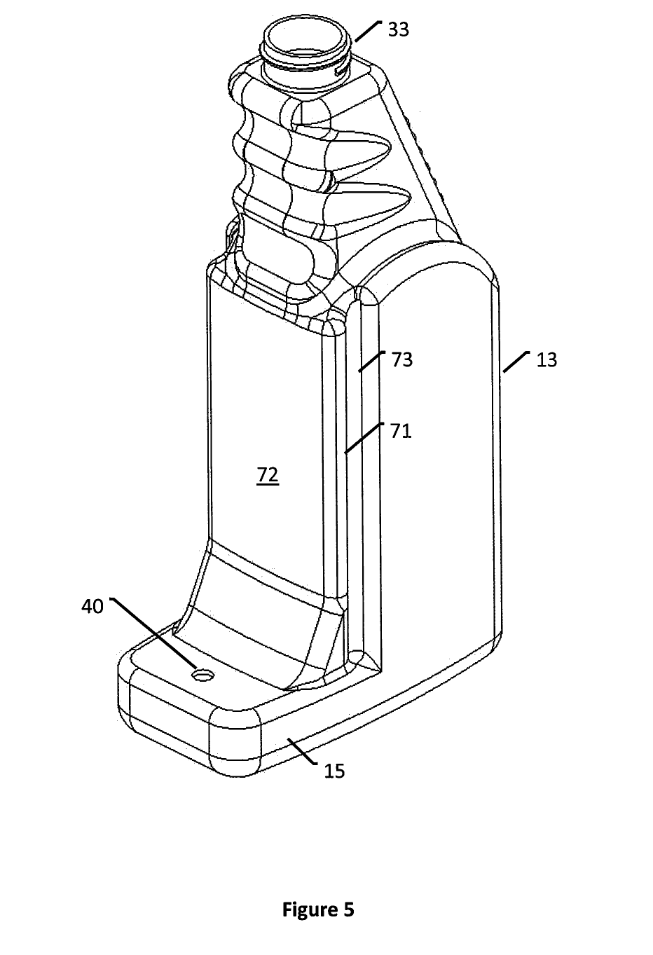

To supply concentrate for mixing, the user may merely press downwardly on the upwardly facing bottom wall 24 of the inverted cartridge 21 to press the body of the container downwardly thereby engaging the flange 63 (FIG. 5) with the top of the receiver 43 and, upon further downward travel of the cartridge, compressing the cartridge valve device to thereby actuate the aerosol can valve to open such valve and release concentrate under pressure through the stem, downwardly into the dock 15 to mix with the water. Once the desired quantity of concentrate has been applied, the container 13 may be shaken to mix the concentrate and water thus readying it for application either through a spray applicator or, for instance, a drinking spout applicator. For the burst valve model, it will be appreciated that ½ ounce concentrate will be metered out.

In our cartridge, we have constructed the cartridge to emit ½ oz. of concentrate or supplement with each operation to provide for rapid and accelerated discharge of the desired charge.

For the mixing of carbonated soda the cartridge is charged with CO₂ to dispense ½ oz. of CO₂ with each actuation to mix with, for instance, flavored water to provide a carbonated drink. As will be apparent to those skilled in the art, the concentrate and mixing container of the present invention have many applications where a concentrate is to be diluted, including detergents, disinfectants, carbonated and non-carbonated beverages and any other application for rapid and efficient mixing.

From the foregoing, it will be appreciated that the method and apparatus of the present invention provides an economical and convenient means for charging cartridges with concentrate for inventorying and storage and shipping and then for rapid and quick release of the desired quantity of concentrate into a dilutent such as water with a minimum of spillage or leakage. This then encourages the user to use the cartridge of the present invention to thereby reduce the inventory and shipping costs and also providing for reuse of the container to thereby reduce the problems attendant to discard thereof single usage or physical replenishing of, for instance, detergent or disinfectant containers after use.

I claim:

1. Combination applicator and concentrate holder apparatus for holding a pressurized concentrate cartridge having a spring loaded spout device formed with an actuator to reciprocate along an actuator path and depressible to open a valve and comprising:
a mixing container configured with a vertical main body defining a mixing chamber for receiving concentrate and a dilutent and a bottom portion projecting laterally from one side of the main body to define a dock having a top wall formed with an opening;
the container including a first coupler on the one side;
a receiver mounted in the opening for receiving the spout device and formed with a stop disposed in the actuator path;
a holder including a second coupler for coupling with the first coupler and constructed for receiving the cartridge and configured to, when the couplers are coupled together, position the cartridge to hold the spout in alignment with the receiver and hold the actuator in the actuator path to, upon the cartridge being pressed downwardly a selected distance in the holder, actuate the valve to inject concentrate under pressure into the container; and
a check valve in the receiver, operable to admit concentrate from the spout and to, when the spout is removed from the receiver, to restrict escape of fluid.

2. The apparatus of claim 1 wherein;
the receiver includes a duckbill valve.

3. The apparatus of claim 1 wherein:
the first and second couplers include a pair of tongues and grooves;

4. The apparatus of claim 1 wherein:
the container is a blow molded container formed with a thin wall;

5. The apparatus of claim 1 wherein:
the receiver is formed with a barrel defining a downwardly and inwardly tapered bore.

6. The apparatus of claim 1 wherein:
the holder is formed with a cylindrical ring for slip fit of the can therein for free movement axially therein.

7. The apparatus of claim 1 wherein:
the cartridge includes a metering valve for emitting a predetermined quantity of concentrate.

8. A combination concentrate applicator and mixing apparatus comprising:
a vertically elongated container configured with the transfer wall formed with a through bore;
a holder mounted to the container for holding a pre-pressurized cartridge of concentrate for reciprocation of the spout and the cartridge through a predetermined path in alignment with the bore; and
a receiver mounted in the bore and including a normally closed valve openable to receive the spout and including a stop disposed in the path of the spout to, after travel of the spout a selected distance toward the receiver, stop the spout whereby further travel of the cartridge toward the received will operate to open the spout valve.

9. The applicator and mixing apparatus of claim 8 for use with a cartridge including a stem device formed with an actuator flange and wherein;
the receiver includes a grommet formed with a horizontal stop wall disposed in the path of the flange as the stem is inserted in the receiver.

10. The applicator and mixing apparatus of claim 8 wherein;
the container is constructed of thin walled blow molded thermoplastic.

11. The applicator and mixing apparatus of claim 8 wherein:
the container is formed with a coupler, including a pair of horizontally outwardly opening grooves; and
the holder includes a pair of arms formed with distal ends defining respective tongues received releasably in the respective grooves.

12. The applicator and mixing apparatus of claim 8 wherein:
the container includes a horizontally projecting foot having one wall defining the transverse wall.

13. The applicator and mixing apparatus of claim 8 wherein:
the receiver includes a duckbill valve.

14. The applicator and mixing apparatus of claim 8 wherein:
the cartridge is in the form of an aerosol can.

15. The applicator and mixing apparatus of claim 8 wherein:
the cartridge includes a metering valve for emitting a predetermined quantity of concentrate.

16. A combination concentrate and mixing container apparatus comprising:
a mixing container constructed with thin blow molded walls forming a vertical mixing chamber having a front wall and configured in the lower extremity with a hollow foot projecting forwardly of the plane of the front wall;
the foot including a top wall formed with a through bore;
the front wall configured with a forward coupler formed with laterally outwardly opening vertical grooves;
a receiver received in the through bore, including a barrel formed with a gland receiving the marginal edge of the top wall around the bore and further formed with a vertical barrel configured with a central passage and terminating in a duckbill valve;
the receiver further including a stop flange defining an upwardly facing stop surface;
an inverted, pre-pressurized cartridge including, on its lower extremity, a stem device formed with a stem to be received in the receiver and further including an actuator flange to, upon pressing of the cartridge downwardly, engaging the stop surface to, upon further downwardly travel of the cartridge depress the stem upwardly relative to the cartridge to open the stem valve; and
a holder for embracing the cartridge to hold the cartridge aligned with the receiver and constructed for free vertical reciprocation of the cartridge, the holder including a pair of flexible arms formed with free extremities configured at respective free extremities with respective tongues for releasable receipt in the respective grooves.

17. The applicator and mixing apparatus of claim 16 wherein:
the holder is formed with at least one ring configured to provide a clearance of at least 0.003 inches around the cartridge.

18. The applicator and mixing apparatus of 16 wherein:
the cartridge is in the form of an aerosol can.

19. A method of mixing a concentrate with a dilutent comprising:
selecting a mixing chamber formed with a horizontally projecting dock having a top wall including a receiver;
selecting a pre-pressurized cartridge of concentrate and of the type including a valve device including a spout having an actuator surface;
mounting a holder to the container for holding the cartridge in alignment with the receiver for, upon the cartridge being pressed downwardly in the holder, engaging the spout with the receiver to stop the spout while continuing to press the cartridge downwardly to actuate a valve in the cartridge to eject a charge of concentrate into the dock
